(19) United States
(12) Patent Application Publication
(10) Pub. No.: US 2020/0104813 A1
(43) Pub. Date: Apr. 2, 2020

(54) REAL-TIME CARBON OFFSET DETERMINATION

(71) Applicant: Thomas Purves, San Francisco, CA (US)

(72) Inventor: Thomas Purves, San Francisco, CA (US)

(21) Appl. No.: 16/149,508

(22) Filed: Oct. 2, 2018

(51) Int. Cl. G06Q 20/10; G06Q 20/40; G06Q 30/06; G06Q 50/06

(52) U.S. Cl. CPC G06Q 20/108; G06Q 50/06; G06Q 30/0627; G06Q 20/405

(57) ABSTRACT

A system and method is disclosed. A network computer can receive an authorization request message comprising access data. The network computer can also receive product data for a transaction. The network computer can then determine an offset value based on the product data. The network computer can then perform additional processing based upon the offset value.

### BACKGROUND

When goods are produced or services are provided to a consumer there is typically an impact on the environment associated with the goods or services (e.g., an amount of carbon is emitted into the atmosphere, energy is consumed, etc.). For example, when a consumer purchases an airline ticket, as least a portion of the carbon gases emitted from the flight of that airplane can be attributed to the purchase of that ticket. A “carbon offset” can include a quantifiable amount of an activity or action that is environmentally-friendly that can be purchased to mitigate or negate the environmental impact of the goods or services. However, it can be challenging to identify and/or determine an appropriate carbon offset to associate with the production of the goods or the provision of the service. In particular, it can be difficult to identify and/or determine an appropriate carbon offset in real-time at the time purchase of the goods or service.

Embodiments address these and other problems individually and collectively.

### BRIEF SUMMARY

One embodiment of the disclosure is directed to a method comprising: receiving, by a network computer, an authorization request message comprising access data; receiving, by the network computer, product data for a transaction; determining, by the network computer, an offset value based on the product data; and performing additional processing, by the network computer, based upon the offset value.

Another embodiment of the disclosure is directed to the server computer comprising: a processor; a memory device; and a computer-readable medium coupled to the processor, the computer-readable medium comprising code executable by the processor for implementing a method comprising: receiving an authorization request message comprising access data; receiving product data for a transaction; determining an offset value based on the product data; and performing additional processing based upon the offset value.

Further details regarding various embodiments can be found in the Detailed Description and the Figures.

### BRIEF DESCRIPTION OF THE DRAWINGS

The example embodiment(s) of the present invention are illustrated by way of example, and not in way by limitation, in the figures of the accompanying drawings and in which like reference numerals refer to similar elements and in which:

FIG. 1 shows a block diagram of a system illustrating an offset system according to one or more embodiments.

FIG. 2 shows a block diagram illustrating a network computer according to one or more embodiments.

FIG. 3 shows a flow diagram illustrating a offset method according to one or more embodiments.

FIG. 4 shows a flow diagram illustrating a notification method according to one or more embodiments.

FIG. 5 shows a flow diagram illustrating a clearance and carbon offset method according to one or more embodiments.

FIG. 6 shows a flow diagram illustrating an alternate clearance and carbon offset method according to one or more embodiments.

While each of the figures illustrates a particular embodiment for purposes of illustrating a clear example, other embodiments may omit, add to, reorder, and/or modify any of the elements shown in the figures.

### DETAILED DESCRIPTION

Prior to discussing various embodiments, some terms can be described in further detail.

An “access device” may be any suitable device that provides access to a remote system. An access device may also be used for communicating with a portable device, a resource provider computer, a network computer, an authorizing entity computer, or any other suitable system. An access device may generally be located in any suitable location, such as at the location of a merchant. An access device may be in any suitable form. Some examples of access devices include point of sale (POS) devices (e.g., POS terminals), cellular phones, personal digital assistants (PDAs), personal computers (PCs), tablet PCs, hand-held specialized readers, set-top boxes, electronic cash registers (ECRs), automated teller machines (ATMs), virtual cash registers (VCRs), kiosks, security systems, access systems, and the like. In some embodiments, an access device can be a device that acts as a payment terminal at a gas station or other location. In some embodiments, where an access device may comprise a POS terminal, any suitable POS terminal may be used and may include a reader, a processor, and a computer-readable medium.

An access device may use any suitable contact or contactless mode of operation to send or receive data from, or associated with, a mobile communication or payment device. For example, access devices can have card readers that can include electrical contacts, radio frequency (RF) antennas, optical scanners, bar code readers, or magnetic stripe readers to interact with portable devices such as payment cards.

“Access data” may include any suitable data that can be used to access a resource or create data that can access a resource. In some embodiments, access data may be account information for a payment account. Account information may include a PAN, payment token, expiration date, card verification values (e.g., CVV, CVV2), dynamic card verification values (dCVV, dCVV2), etc. In other embodiments, access data could include data that can be used to access a location or to access secure data. Such information may be ticket information for an event, data to access a building, transit ticket information, passwords, biometrics or other credentials to access secure data, etc.

A “portable device” may comprise any suitable electronic device that may be operated by a user, which may also provide remote communication capabilities to a network. A “portable consumer device” may be an example of a “portable device.” Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of portable devices include mobile phones (e.g., cellular phones), PDAs, tablet computers, net books, laptop computers, personal music players, hand-held specialized readers, etc. Further examples of portable devices include wearable devices, such as smart watches, fitness bands, ankle bracelets, rings, earrings, etc., as well as automobiles with remote communication capabilities. In some embodiments, a portable device can function as and/or include a payment device (e.g., a portable device can store and be able to transmit payment credentials for a transaction).

As used herein, a “payment device” may include any device that may be used to conduct a financial transaction, such as to provide payment information to a merchant. A payment device may be in any suitable form. For example, suitable payment devices can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of payment devices include cellular phones, personal digital assistants (PDAs), pagers, payment cards, security cards, access cards, smart media, transponders, 2-D barcodes, an electronic or digital wallet, and the like. If the payment device is in the form of a debit, credit, or smartcard, the payment device may also optionally have features such as magnetic stripes. Such devices can operate in either a contact or contactless mode.

“Transaction data” may include information associated with a transaction. For example, transaction data may include one or more of an authorized amount (e.g., transaction amount, item value, etc.), other amount, terminal country code, terminal verification results, transaction currency code, transaction date, transaction type (e.g., card-present transaction, card-not-present transaction, high value transaction, low value transaction, local transaction, international transaction, etc.), an unpredictable number, application interchange profile (AIP), application transaction counter (ATC), issuer application data (IAD), etc.

“Product data” may include information associated with products involved in a transaction. Product data may include a number of data items, each of the data items representing a purchased product or service. Each data item may be associated with an item amount, an item cost, an item type and an item identifier. The item identifier may also be referred to as a product identifier and may include a stock keeping unit (SKU), a manufacturer product number, a model number, an international standard book number (ISBN), a universal product code (UPC), and/or any other suitable product identifier. For example, product data for a transaction at a gas station may include a first data item associated with an item type of ‘candy bar’ and an item cost of ‘$2.00’ as well as a second data item associated with an item type of ‘unleaded gasoline,’ an item amount of ‘10 gallons,’ and an item cost of ‘$45.00.’ Product data can include any suitable number of data items and may relate to any suitable type of product or service.

A “user” may include an individual and/or a user account. In some embodiments, a user may be associated with one or more personal accounts and/or portable devices. The user may also be referred to as a cardholder, account holder, or consumer in some embodiments.

“Credentials” may comprise any evidence of authority, rights, or entitlement to privileges. For example, access credentials may comprise permissions to access certain tangible or intangible assets, such as a building or a file. In another example, payment credentials may include any suitable information associated with and/or identifying an account (e.g., a payment account and/or payment device associated with the account). Such information may be directly related to the account or may be derived from information related to the account. Examples of account information may include an “account identifier” such as a PAN (primary account number or “account number”), a token, a subtoken, a gift card number or code, a prepaid card number or code, a user name, an expiration date, a CVV (card verification value), a dCVV (dynamic card verification value), a CVV2 (card verification value 2), a CVC3 (card verification code 3) card verification value, etc. An example of a PAN is a 16-digit number, such as “4147 0900 0000 1234”. In some embodiments, credentials may be considered sensitive information.

A “key” may include a piece of information that is used in a cryptographic algorithm to transform input data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

An “ephemeral public key” may include a cryptographic key that that forms a public key of an ephemeral public/private key pair. In some cases, an ephemeral public key can be used for only a limited period of time or a limited number of times. In some cases, it is used for one event, one time period, or one transaction. The ephemeral public key may be designed to be shared (e.g., transmitted between entities) and may be configured such that any information encrypted with the ephemeral public key may only be decrypted using an ephemeral private key associated with the ephemeral public key.

An “ephemeral private key” may include a cryptographic key that forms a private key of an ephemeral public/private key pair. An ephemeral private key may be used to decrypt data encrypted with an ephemeral public key.

A “key identifier” or “key ID” can be any identifier corresponding to a related key. The key identifier can be in any suitable form and may include any suitable number of characters.

A “cryptogram” may include an encrypted representation of some information. A cryptogram can be used by a recipient to determine if the generator of the cryptogram is in possession of a proper key, for example, by encrypting the underlying information with a valid key, and comparing the result to the received cryptogram. For example, the underlying information may be transaction data.

A “digital signature” may include the result of applying an algorithm which allows a signing party to manifest, and a verifying party to verify, the authenticity and integrity of data. For example, for a public/private key pair, the signing party may act by means of the private key and the verifying party may act by means of the public key. This process may certify the authenticity of the sender and the integrity of the signed document because of the so-called principle of nonrepudiation which does not allow disowning what has been signed. A certificate or other data that includes a digital signature by a signing party is said to be “signed” by the signing party.

An “authorization request message” may be an electronic message that requests authorization for an interaction. In some embodiments, it is sent to a transaction processing computer and/or an issuer of a payment card to request authorization for a transaction. An authorization request message according to some embodiments may comply with International Organization for Standardization (ISO) 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction value, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g., POS equipment) that indicates approval of the transaction. The code may serve as proof of authorization.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer, or in some embodiments, a portable device.

A “merchant” may typically be an entity that engages in transactions and can sell goods or services, or provide access to goods or services.

A “resource provider” may be an entity that can provide a resource such as goods, services, information, and/or access. Examples of resource providers includes merchants, data providers, transit agencies, governmental entities, venue and dwelling operators, etc.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

A “network computer” may include a computer or a network of computers that processes transactions. In some embodiments, the network computer can be in an electronic system used to accept, transmit, or process transactions made by user devices for money, goods, services or access to locations or data. The network computer may transfer information and funds among issuers, acquirers, transacting parties, and users. An example of the network computer may include a payment processing server computer such as VisaNet™, operated by Visa®. Payment processing server computers such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services. In other embodiments, a network computer can be a collection of computers that can allow access to a person seeking to access a particular location. In yet other embodiments, a network computer can be a collection of computers that can allow access to specific types of data (e.g., governmental agencies).

An “interaction” may include a reciprocal action or influence. An interaction can include a communication, contact, or exchange between parties, devices, and/or entities. Example interactions include a transaction between two parties and a data exchange between two devices. Interactions can also be agreements, contracts, and the like.

A “processor” may include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

The systems and methods described herein relate to determining offset values for interactions in real time. More specifically, the systems and methods described herein include generating an offset value for a transaction made by a user using a portable device.

Purchases made by a user may have an impact on the environment. For example, a user that purchases an airline ticket may impact the environment through the carbon emissions emitted by the airplane to transport the user. Similarly, a user that purchases a meal at a restaurant may have caused an impact on the environment through the carbon emissions of the restaurant in preparing the meal, through the farmer's actions in raising the ingredients, through the distribution of the materials to the restaurant, or through other impacts on the environment. In many cases, these emissions or impacts can be quantified for each resource provider that provides a product or service. Further, the emissions or impacts can be quantified for each individual user. For example, for each passenger on one round trip flight from New York City to Los Angeles the airline may release 0.7 metric tons of carbon dioxide into the atmosphere.

In the case of some industries, environmental impact lists exist, which attempt to quantify an amount of impact a particular business type may have on the environment. For example, a business type, such as a restaurant, may be included on one of these lists based on how much carbon a typical or average restaurant would emit. In some cases, a particular restaurant chain may indicate how much carbon a typical restaurant location may emit in operating such a restaurant location. An example of a such a system may apply environmental impact offsets using an environmental impact lists. For example, if a transaction occurred with a gas station, then the consumer may be charged an extra 2% for the environmental impact of the purchase. A general offset factor is applied to every transaction with any gas station, i.e., 2% of every purchase at all gas stations.

The systems and methods described herein are configured to address and/or offset the environmental impact of such interactions performed by users. For example, in an effort to counteract a user's impact on the environment from his or her transactions, the user may decide to participate in environmental offsets using the systems and methods described herein. These environment impact offsets may include donations made to an environmental charity, where the environmental charity supports projects that remove carbon from the atmosphere or reduce future emissions of carbon or other green-house gases. In the New York to Los Angeles example, to counteract the 0.7 metric tons that have been released by the roundtrip flight, the user may donate a percentage of the purchase price of the plane ticket to an environmental charity. Such a donation would offset the carbon that was released into the atmosphere. A user can become carbon neutral by matching the amount of carbon emitted from all of the goods and services purchased with donations to such environmental charities.

As another example, a user may enroll in a carbon offset program wherein a percentage of the user's transaction amounts (e.g., 2% of purchases) are applied to decreasing the environmental impact of the network computer and/or the authorizing entity computer. In one embodiment, decreasing the environmental impact is done through upgrades such as making data centers of the network computer solar-powered or improving the energy efficiency of the data center buildings.

According to the systems and methods described herein, a network computer can determine an offset value based on product data received from an access device or resource provider computer during authorization of a transaction. The network computer may, for example, determine the offset value based on carbon offset data. The network computer can then perform additional processing based on the offset value, such as adjusting a transaction value in an authorization request message, store and later apply the offset value in a clearance process, update a total offset value and notify the user of the total offset value based on an offset threshold, or any other suitable additional processing as described in further detail below.

In some embodiments, a network computer can determine an offset value based on product data that can include stock keeping unit (SKU)-level data which may be shared by resource providers (e.g., travel category merchants) as part of an interchange reimbursement fee (IRF) process. This may allow embodiments to more accurately determine offset values rather than apply a fixed value (e.g., 2%) to a merchant category (e.g., airline), which can be a problem when an interaction, such as a transaction, includes various products such as seat selection, flight upgrades, in-flight purchases, change fees, etc. For example, in the case where the merchant is an airline, the network computer may be capable of determining offset values based on data such as, for example, departure date, origin airport, up to 4 destinations, and the like. As another example, the merchant may be a rail line operator, a cruise company, a rental car company, etc. In these cases the SKU-level data may comprise data fields such as departure date, origin, up to 4 destinations, check-in date, number of nights, return date, volume of fuel purchase, and the like. In yet other embodiments, the network computer may receive self-reported data, via a self-reporting data channel connecting the network computer to a user. The network computer may use the self-reported data in conjunction with the product data to determine offset values.

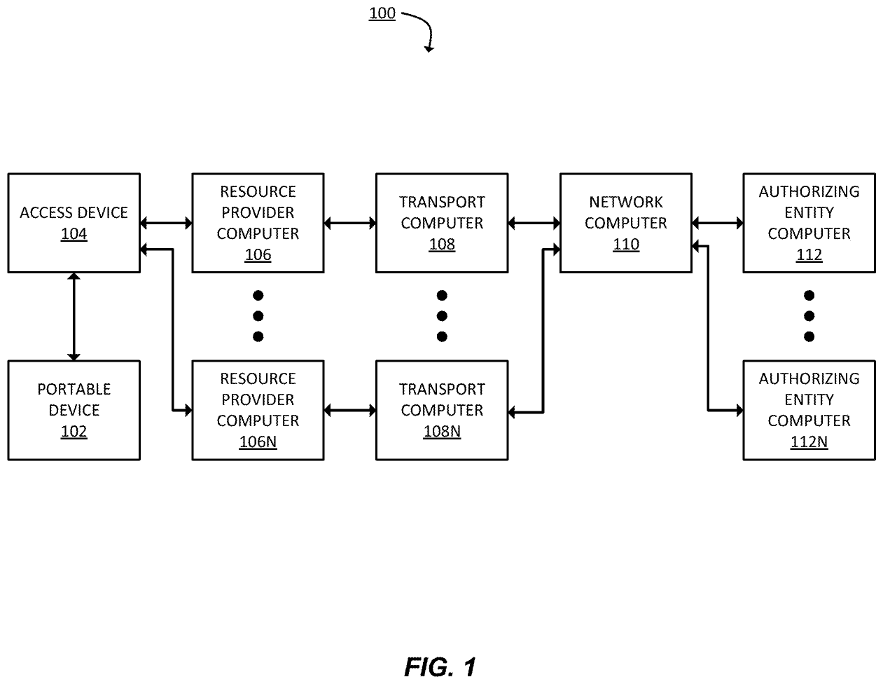

FIG. 1 shows a block diagram of a system 100 comprising a number of components according to some embodiments. System 100 illustrates only one of many possible arrangements of components configured to execute the programming described herein. Other arrangements may include fewer or different components, and the division of work between the components may vary depending on the arrangement. The system 100 comprises a portable device 102, an access device 104, a resource provider computer 106, a transport computer 108, a network computer 110, and an authorizing entity computer 112. The components of the system 100 may all be in operative communication with each other through a communication network.

The communication network may include any suitable communication medium. The communication network may be one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Message between the entities, providers, networks, and devices illustrated in FIG. 1 may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

The portable device 102 may be operated by a user. The user may attempt to perform an interaction, such as a transaction, with a resource provider through the access device 104. For example, the user may use the portable device 102 to conduct a transaction with the access device 104. The portable device 102 may store credentials in a secure memory and may be capable of providing the credentials to the access device 104 after initiating a transaction. In some embodiments, the credentials may include a cryptogram such as an authorization request cryptogram (ARQC), a transaction certificate (TC), or an application authentication cryptogram (AAC).

The access device 104 may be in operative communication with the portable device 102 and the resource provider computer 106. The user may initiate an interaction with the access device 104 using the portable device 102. For example, the user may approach the access device 104 at a resource provider location to purchase one or more goods and/or services. The access device 104 may begin receiving information about items for purchase and summing the amount for each item (e.g., during an “ECR or electronic cash register tender” process). The access device 104 may request the user to provide a portable device 102. The user may then provide the portable device 102 to the access device 104. For example, the portable device 102 may be inserted into the access device 104, or otherwise physically connected to the access device 104. A contact interface (e.g., a chip plate) on the portable device 102 may come in direct contact with a second contact interface at the access device 104. As a result, the access device 104 may be able to communicate with the portable device 102 for transaction processing. The access device 104 may also be capable of generating an authorization request message comprising access data and then transmitting the authorization request message to a resource provider computer 106 or, in some embodiments, to the transport computer 108. In some embodiments, the access device 104 may transmit the authorization request message to the resource provider computer 106 via a first communications channel and may transmit product data to the network computer 110 via a second communications channel.

The resource provider computer 106 may be associated with a resource provider, which may be an entity that can provide a resource such as goods, services, information, and/or access. In some embodiments, the resource provider computer 10 may be a backend system for the access device 104. The resource provider computer 106 may be configured to receive and access data. The resource provider may accept multiple forms of payment (e.g., the portable device 102) and may use multiple tools to conduct different types of transactions. For example, the resource provider may operate a physical store and use the access device 104 for in-person transactions. The resource provider may also sell goods and/or services via a website, and may accept payments over the Internet.

The transport computer 108 may be located between (in an operational sense) the resource provider computer 106 and the network computer 110. The transport computer 108 may be operated by an entity such as an acquirer. An acquirer can maintain an account of any merchants (e.g., an airline) with which users may wish to interact. In some embodiments, the transport computer 108 may be in operative communication with the access device 104. For example, the transport computer 108 may receive an authorization request message from the access device 104 and may forward the authorization request message to the network computer 110.

The network computer 110 may route or switch messages between a number of transport computers including the transport computer 108 and the transport computer 108N, and a number of authorizing entity computers including the authorizing entity computer 112 and the authorizing entity computer 112N. The network computer may be a processing network computer in some embodiments. The processing network computer may be configured to provide authorization services, and clearing and settlement services for payment transactions. A processing network computer may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services. Furthermore, the payment processing network may include a server computer and may use any suitable wired or wireless telecommunications network, including the Internet. In some embodiments, the processing network computer may forward an authorization request received from a transport computer to the authorizing entity computer via a communication channel. The processing network computer may further forward an authorization response message received from the authorizing entity computer 112 to the transport computer 108.

The authorizing entity computer 112 may be configured to authorize any suitable request, including access to data, access to a location, or approval for a payment. In some embodiments, the authorizing entity computer 112 may be operated by an account issuer. Typically, the issuer is an entity (e.g., a bank) that issues and maintains an account of a user. The account may be a credit, debit, prepaid, or any other type of account.

FIG. 1 also includes a resource provider computer 106N, a transport computer 108N, and an authorizing entity computer 112N. Any suitable number of resource provider computers, transport computers, and authorizing entity computers may be present in the system 100. In some embodiments, each computer in the system 100 may store a routing table that allows the computer to route messages to a suitable receiving computer.

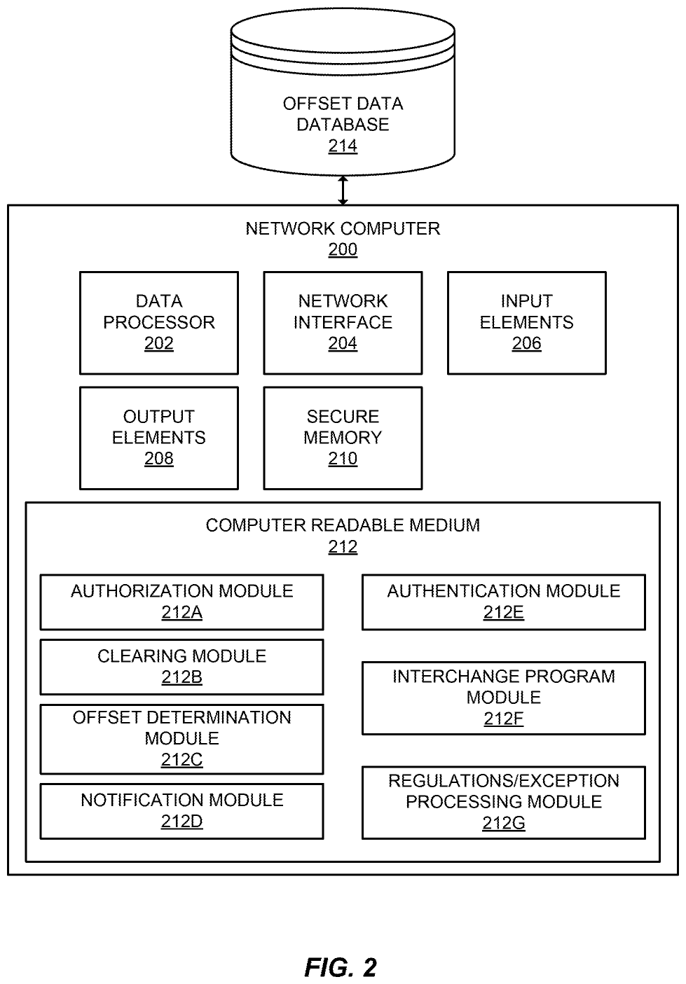

FIG. 2 shows a block diagram of a network computer 200 according to some embodiments. The network computer 200 may comprise a processor 202. The processor 202 may be coupled to a network interface 204, input elements 206, output elements 208, a secure memory 210, and a computer readable medium 212 comprising an authorization module 212A, a clearing module 212B, an offset determination module 212C, a notification module 212D, an authentication module 212E, an interchange program module 212F, and a regulations/exception processing module 212G. FIG. 2 also includes an offset data database 214 operatively coupled to the network computer 200.

The network interface 204 may include an interface that can allow the network computer 200 to communicate with external computers. Network interface 220 may enable the network computer 200 to communicate data to and from another device (e.g., resource provider computer, transport computer, authorization computer, etc.). Some examples of network interface 204 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by network interface 204 may include Wi-Fi™.

Data transferred via network interface 204 may be in the form of signals which may be electrical, electromagnetic, optical, or any other signal capable of being received by the external communications interface (collectively referred to as “electronic signals” or “electronic messages”). These electronic messages that may comprise data or instructions may be provided between network interface 204 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The input elements 206 may include any suitable device(s) capable of inputting data into the network computer 200. Examples of input elements 206 include buttons, touchscreens, touch pads, microphones, etc.

The output elements 208 may comprise any suitable device(s) that may output data. Examples of output elements 208 may include display screens, speakers, and data transmission devices.

The secure memory 210 may store encrypted access data, key identifiers, public keys, and any other relevant data securely. The secure memory 210 may be in the form of a secure element, a hardware security module, or any other suitable form of secure data storage.

The computer readable medium 212 may comprise code, executable by the processor 202, to implement a method comprising: receiving an authorization request message comprising access data and receiving product data for a transaction; determining an offset value based on the product data; and performing additional processing based upon the offset value.

The authorization module 212A may comprise code, executable by the processor 202 to validate data elements (such as tokens, credentials, etc.), to provide a token assurance level, to provide support for lost and stolen devices, and for token exchange.

The authorization module 212A may also comprise code, executable by the processor 202, to process an authorization request message comprising a token (or PAN). In one embodiment, the authorization module 212A, in conjunction with the processor 202, may validate a token requestor identifier to determine if the transaction can be approved or declined. For example, the token requestor identifier may be associated with a wallet application that may be used by the user to initiate a transaction using the portable device 102. The token requestor identifier may be provided by a network token system to the wallet application during the onboarding process. In some embodiments, the authorization module 212A may approve or decline the transaction using various data associated with the transaction such as a token presentment mode, token number, token timestamp, token expiration date, token assurance level, a determination that the account used to conduct the transaction is lost, stolen, or compromised, or any other suitable data. The aforementioned data may be determined from the contents of the authorization request message for a transaction, a token registry database, or any other suitable source.

In one embodiment, the authorization module 212A, working in conjunction with the processor 202, may provide support for token exchange. For example, the authorization module 212A may modify the authorization request message to replace a token with a PAN and send the modified authorization request message to the authorizing entity computer 112. The authorization module 212A may also restore the token in the authorization response message received from the authorizing entity computer 112 before forwarding it to the transport computer 108. In some embodiments, records of the authorization may be contained in an authorization log database that can be transmitted to participating acquirers. The data contained in the authorization log database can be in a plurality of file formats.

The clearing module 212B may comprise code for performing clearance. The clearing module 212B may be configured to process clearing transactions. A clearing process may be performed to reconcile orders among the transacting entities such as the authorizing entity computer 112, the network computer 200, and the transport computer 108/resource provider computer 106. When a token is used in a clearing draft message, a token requestor identifier may be present in the appropriate data field. In one embodiment, for Base II processing, the clearing module 212B can substitute a token with a PAN in received clearing draft messages for related clearing processing. In some embodiments, if the authorization was conducted with a token, the token is replaced with a PAN in the authorization data files provided to the transport computer 108. The token number and expiration date can be processed pursuant to existing rules and can be provided in the clearing draft message (e.g., in the expiration date field).

In some embodiments, the clearing draft message may include a token assurance level. In one embodiment, at the time of transaction processing, if the token requestor identifier is present, the token can be validated against the token requestor identifier to which the token was originally issued. If the validation fails, the network computer 200 may return an appropriate code in the clearing draft message. In some embodiments, based on the issuer option of receiving the token requestor identifier, the network computer 200 may forward the token requestor identifier in the clearing draft message to the authorizing entity computer 112. In some embodiments, the transport computer 108 may retain and return the token requestor identifier value used in the original transaction in all the subsequent transactions. In one embodiment, the POS condition code and the POS entry mode code fields can reflect the applicable token presentment mode in the clearing draft message.

The network computer 200 may comprise a settlement module in some embodiments. The settlement module may comprise code for performing settlement. A settlement process may be performed to reconcile accounts between transacting entities such as the authorizing entity computer 112, the network computer 200, and the transport computer 108/resource provider computer 106. The settlement process may be performed following the clearance process. The network computer 200 can determine financial compensations between issuers and acquirers. The transfer of funds between entities may be, in some embodiments, performed through a settlement bank, which can be designated by the network computer 200. Acquirers and issuers may have accounts with the settlement bank. After all the transaction amounts are determined, during a clearance process, a total can be determined that reflects the amount to be debited from the issuer's account kept with the settlement bank. The issuer can be notified about the settlement of its debt. The network computer 200 can repeat this process for each issuer that participated in the clearing. The amount can be credited to the acquirer's account kept with the settlement bank. The network computer 200 can notify the transport computer 108 about the crediting of the account.

The offset determination module 212C may comprise code for calculating an offset value. For example, the offset determination module 212C may be capable of determining an offset value based on offset data received from the offset data database 214. In some embodiments, the offset data may be an equation. The offset determination module 212C may evaluate the equation using the product data to determine the offset value. In other embodiments, the offset data may be a table of conversions between product data and offset values.

The notification module 212D may comprise code for generating and transmitting notifications. For example, the network computer 200 may determine if a total offset value exceeds an offset threshold. The network computer 200 can generate a notification including the total offset value and, in some embodiments, the offset threshold. The network computer 200 can also transmit the notification to a remote computer, such as a user device, associated with the user.

The total offset value may be a sum of the pending offset values associated with a particular user. For example, the network computer 200 may update the total offset value associated with a user after each transaction initiated by the user. If a previous total offset value is $22.95 and the network computer 200 determines an offset value for a transaction to be $2.00, then the network computer 200 can update the total offset value to be $24.95. The offset threshold can be a predetermined threshold. The user may be capable of setting the offset threshold. For example, the user may want to be notified once the total offset exceeds an offset threshold of $100. Once the network computer 200 determines that the total offset value (e.g., $103) exceeds the offset threshold (e.g., $100), then the network computer can generate and transmit a notification regarding the total offset value. As an example, the notification can include text such as “Your current carbon offset has passed $100, it is currently at $103.”

The authentication module 212E may comprise code that can be executed by the processor 202 to apply one or more authentication methods to authenticate the user of the portable device 102. In one embodiment, the authentication module 212E may comprise code for authenticating a QR™ code token transactions using existing authentication schemes (e.g., entering personal information into a keypad). In another example, the authentication module 212E may comprise code for authenticating contactless EMV token transactions based on dCVVs that are formed with or without ATCs (Application Transaction Counters) or cryptograms. The authentication module 212E may be capable of authenticating the user in any suitable manner.

The interchange programs module 212F may comprise code for determining interchange rates and fees for transactions. Payment transactions can qualify for existing fee programs and interchange rates applicable to the respective presentment modes and available card products.

The regulations/exception processing module 212G may be configured to apply operating regulations and perform liability and dispute processing for payment transactions. Payment transactions can qualify for existing liability rules applicable to the respective presentment modes and available card products. For example, acquirers and issuers can qualify for existing chargeback rules based on the presentment modes. In some embodiments, the regulations/exception processing module 212G can map tokens used in the original transactions to facilitate dispute processing related to chargebacks.

The offset data database 214 may securely store data, such as offset data. The offset data may refer to information associated with an offset. For example, the offset data may be carbon offset data, methane offset data, coal offset data, natural gas offset data, chlorofluorocarbon offset data, and the like. Carbon offset data can be data that relates product data to an amount to carbon created in the generation and provision of the product. For example, carbon offset data may include data indicating that for a passenger on a round trip flight from New York City to Los Angeles the airline may release 0.7 metric tons of carbon dioxide into the atmosphere. The carbon offset data may also include a monetary amount associated with 0.7 metric tons of carbon dioxide. The offset data database 214 may be a conventional, fault tolerant, relational, scalable, secure database such as those commercially available from Oracle™ or Sybase™.

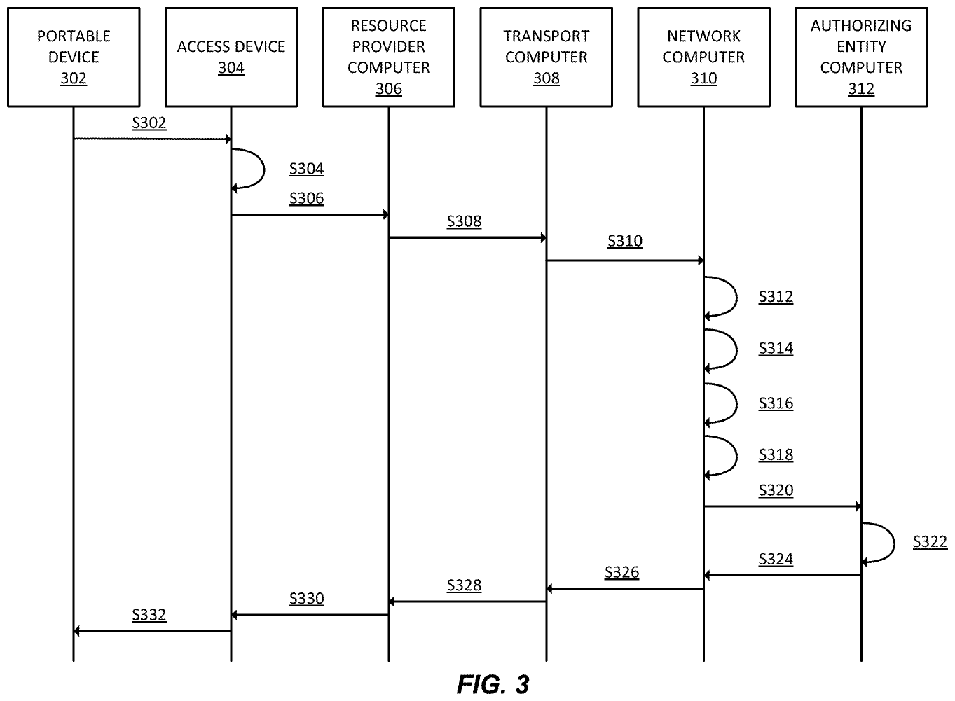

FIG. 3 shows a flow diagram illustrating an offset method according to some embodiments. The method illustrated in FIG. 3 will be described in the context of a user purchasing items from a gas station using a portable device at an access device. The user and the resource provider may be enrolled in a carbon offset program. The network computer may determine an offset value and offset a transaction value with the offset value before the transaction is authorized at the authorizing entity computer. It is understood, however, that the teachings of these embodiments can be applied to other circumstances (e.g., other types of merchants, different enrollment programs, various applications of the offset value as described herein, etc.). Although the steps are illustrated in a specific order, it is understood that embodiments may include methods that have the steps in different orders. In addition, in some embodiments, steps may be omitted or added.

Before S302, the user may enroll the user's portable device 302 in a carbon offset program. The carbon offset program may be offered by the resource provider computer 306, the transport computer 308, the network computer 310, and/or the authorizing entity computer 312. In some embodiments, the resource provider may also enroll in the carbon offset program. In other embodiments, the resource provider may be enrolled in the carbon offset program, while the user may not be enrolled in the carbon offset program.

The user may select one or more goods and/or services for purchase at the resource provider, and then initiate a payment transaction. The user may choose to pay via the portable device 302. In some embodiments, the user may activate a digital wallet application in the portable device 302, select a payment account, and initiate payment functionality with the portable device 302.

At step S302, the user may hold the portable device 302 near to (e.g., within communication proximity of) or connected with the access device 304. The portable device 302 can transmit access data to the access device 304. The access data can comprise account information for a payment account. For example, the access data can comprise a PAN, payment token, expiration date, card verification values (e.g., CVV, CVV2), dynamic card verification values (dCVV, dCVV2), etc. The access device 304 can receive the access data in any suitable manner, e.g., via a contact or a contactless interface.

At step S304, after receiving the access data from the portable device 302, the access device 304 can generate an authorization request message. The authorization request message can comprise the access data as well as transaction data. The transaction data can include data regarding the transaction. For example, the transaction data can include one or more of an amount (e.g., purchase amount, item value, etc.), other amount, terminal country code, terminal verification results, transaction currency code, transaction date, transaction type, merchant specific information, and/or any other suitable transaction data described herein. In some embodiments, the access device 304 can include product data in the authorization request message. The product data may include a number of data items, each data item associated with an item amount, an item cost, an item type, and an item identifier, as described above. For example, the product data can include two data items. A first data item can relate to a candy bar which can be associated with an item cost of $2.00, an item amount of 1, and an item type of food, candy bar, or other suitable item type. The first data item can have an item identifier of 040000424314, as an example. A second data item can relate to gasoline which can be associated with an item cost of $45.00, an item amount of 10 gallons, and an item type of unleaded gasoline. The second data item, for example, can have an item identifier of UNGAS-95. At step S306, the access device 304 can then transmit the authorization request message to the resource provider computer 306.

At step S308, the resource provider computer 306 can receive the authorization request message from the access device 304 and can then forward the authorization request message to the transport computer 308. In some embodiments, the access device 304 may transmit the authorization request message to the transport computer 308.

At step S310, the transport computer 308 can receive the authorization request message from the resource provider computer 306 and can forward the authorization request message to the network computer 310. The transport computer 308 can store a routing table and can determine which network computer to forward the authorization request message to, based on the routing table.

At step S312, after receiving the authorization request message, the network computer 310 can determine if the portable device 302 is enrolled in a carbon offset program. For example, the network computer 310 can query a carbon offset enrollment database for a user profile associated with the PAN, or other user identifier, from access data in the authorization request message. The network computer 310 can determine whether or not the user previously created a user profile during enrollment into the carbon offset program. If the network computer 310 determines that the portable device 302 is not enrolled in the carbon offset program, then the network computer 310 can proceed with authorization and can forward the authentication request message to the authorizing entity computer 312. If the network computer 310 determines that the portable device 302 is enrolled in the carbon offset program, then the network computer 310 may proceed to step S314.

At step S314, the network computer 310 can determine if the resource provider computer 306 is enrolled in the carbon offset program. For example, the network computer 310 can query the carbon offset enrollment database for a merchant profile associated with the access device 304 and/or the resource provider computer 306. In some embodiments, the user profiles and the merchant profiles may be stored in the same carbon offset enrollment database. In other embodiments, the user profiles may be stored in a user profile database, whereas the merchant profiles may be stored in the merchant profile database. If the network computer 310 determines that the resource provider computer 306 is not enrolled in the carbon offset program, then the network computer 310 can proceed with authorization and can forward the authentication request message to the authorizing entity computer 312. If the network computer 310 determines that the resource provider computer 306 is enrolled in the carbon offset program, then the network computer 310 may proceed to step S316.

In some embodiments, the network computer 310 may perform step S312 and not perform S314. In other embodiments, the network computer 310 may perform step S314 and not S312. The network computer 310 may determine the entities that are enrolled in the carbon offset program. For example, the carbon offset program may allow users to pay for the cost of a carbon offset for each of the user's purchases. In this case, the network computer 310 may determine if the user is enrolled in the carbon offset program. As another example, the carbon offset program may allow merchants to pay for the cost of a carbon offset for each item sold by the merchant. In this case, the network computer 310 may determine if the merchant is enrolled in the carbon offset program.

At step S316, after verifying that the portable device 302 and/or the resource provider computer 306 are enrolled in the carbon offset program, the network computer 310 can determine an offset value based on the product data. For example, the product data may indicate that the user is purchasing 10 gallons of unleaded gasoline from a gas station. The network computer 310 can query an offset data database for carbon offset data regarding the product data (e.g., unleaded gasoline). In some embodiments, the network computer 310 may obtain a table of various amounts of different types of gasoline and their carbon costs. The network computer 310 can determine the offset value based on the carbon cost of 10 gallons of unleaded gasoline. In some embodiments, the network computer 310 may determine an estimate for the amount of carbon generated in the creation of the 10 gallons of unleaded gasoline and its provision to the user, then determine the offset value based on the amount of carbon.

In other embodiments, the network computer 310 can obtain a carbon equation that relates the product data to the amount of carbon generated. The carbon equation can compute an estimate of the amount of carbon created based on inputs (e.g., product data). For example, the inputs to the carbon equation may be amount of fuel (e.g., 10 gallons) and type of fuel (e.g., unleaded gasoline), which may be included in the product data. The carbon equation may be predetermined and stored in the carbon offset data database.

As an example, the product data can include the 10 gallons of unleaded gasoline as a first data item as well as a $2 candy bar as a second data item. The network computer 310 can determine an offset value for each data item in the product data. The network computer 310 can determine a larger offset value for the 10 gallons of unleaded gasoline than the offset value for the $2 candy bar. The network computer 310 can determine an offset value for the product data which, in this case, may be equal to the sum of the offset value for the first data item and the offset value for the second data item.

In some embodiments, the user of the portable device 302 can opt for the offset value to be reduced or increased by a certain percentage, which would decrease or increase, respectively, the offset value determined by the network computer 310. The network computer 310 may store the user's selected percentage in the user profile, described above. For example, the user may set the percentage to be a reduction of 50%. In this case, the offset values determined for the user can be reduced by half. This may be a way for a user to ramp up participation in the program by starting at a lower percentage and increasing it over time. As another example, the user may set the percentage to be an increase of 25%, thus allowing the user to increase their environmental impact offsets and making the user carbon negative.

At step S318, after determining the offset value, the network computer 310 can adjust a transaction value, included in the authorization request message, by the offset value resulting in an adjusted transaction value. For example, the network computer 310 may determine that the offset value for a $47.00 transaction is $5.00. The network computer 310 can add the offset value to the transaction value to determine the adjusted transaction value of $52.00.

At step S320, after offsetting the transaction value, the network computer 310 can include the adjusted transaction value in the authorization request message and transmit the authorization request message comprising the access data, the offset data, and the adjusted transaction value to the authorizing entity computer 312.

At step S322, after receiving the authorization request message, the authorizing entity computer 312 can determine whether or not to authorize the transaction. The authorizing entity computer 312 may determine whether to authorize the transaction. For example, the authorizing entity computer 312 may validate a cryptogram (e.g., an ARQC), check for sufficient funds in the user's account, perform a risk analysis, and complete any other steps in order to determine whether to authorize the transaction. The authorizing entity computer 312 can then generate an authorization response message. The authorization response message can include an indication if the transaction was approved or declined. The authorization response message may also include an authorization code. In some embodiments, the authorization response message may include the adjusted transaction value.

At step S324, after the authorizing entity computer 312 generates the authorization response message, the authorizing entity computer 312 can transmit the authorization response message to the network computer 310. At step S326, the network computer 310 can forward the authorization response message to the transport computer 308. At step S328, after receiving the authorization response message from the network computer 310, the transport computer 308 can forward the authorization response message to the resource provider computer 306. At step S330, in some embodiments, the resource provider computer 306 can forward the authorization response message to the access device 304 which may, at step S332, forward the authorization response message to the portable device 302. In some embodiments, the access device 304 may display an appropriate message to the user and/or store clerk, and the resource provider may release the purchased goods and/or services to the user. In some embodiments, the access device 304 may display the adjusted transaction value.

At the end of the day or at some other suitable time interval, a clearing and settlement process between the transport computer 308, the network computer 310, and the authorizing entity computer 312 may be performed on the transaction, as described herein.

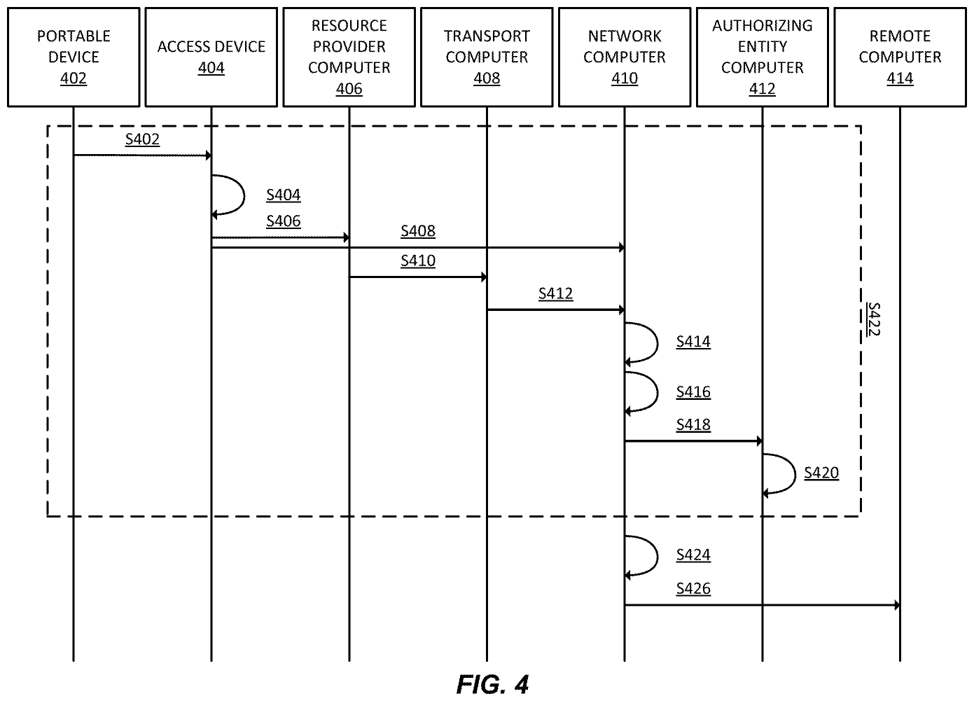

FIG. 4 shows a flow diagram illustrating a notification method according to some embodiments. The method illustrated in FIG. 4 will be described in the context of a network computer notifying a user of a total offset value associated with a plurality of transactions. It is understood, however, that the teachings of these embodiments can be applied to other circumstances. Although the steps are illustrated in a specific order, it is understood that embodiments may include methods that have the steps in different orders. In addition, in some embodiments, steps may be omitted or added.

Step S402 is substantially similar to step S302 described above and will not be repeated here. At step S404, the access device 404 can generate an authorization request message comprising access data and transaction data, as described herein. The transaction data can include a transaction identifier. The transaction identifier can be any suitable data used to identify the transaction. The transaction identifier can, for example, be a string of alphanumeric characters of any suitable length (e.g., 15 characters). At step S406, the access device 404 can transmit the authorization request message to the resource provider computer 406 via a first communications channel. The first communications channel can be a communications channel that includes messages in an ISO 8583 data format and/or may include the transport computer 508 as a node in the channel.

At step S408, the access device 404 can transmit product data associated with the transaction to the network computer 410 via a second communications channel. The second communications channel may involve a web based communication or communication through an API of the network computer 510. In some embodiments, the second communications channel may not be a high capacity data channel and may not be as fast as the first communications channel. The product data can be transmitted along with the transaction identifier. The access device 404 can transmit the product data directly to the network computer 410. In other embodiments, the access device 404 can transmit the product data to the resource provider computer 406, wherein the resource provider computer 406 can store the product data for the resource provider's records. In some embodiments, the product data may be level III data such as stock keeping unit (SKU) data. Steps S410-S412 are substantially similar to steps S308-S310 described above and will not be repeated here.

At step S414, after receiving an authorization request message and the product data, the network computer 410 can match the authorization request message to the corresponding product data using the transaction identifier. For example, the authorization request message may comprise transaction data including a transaction identifier of 0001285. The product data may include a transaction identifier of 0001285. The network computer 410 can determine that the authorization request message and the product data are associated with the same transaction. The network computer 410 can then verify that the portable device 402 is enrolled in a carbon offset program, as described herein (e.g., at step S312 in FIG. 3).

At step S416, after determining that the portable device 402 is enrolled in the carbon offset program, the network computer 410 can determine an offset value as described herein. The network computer 410 can add the offset value to a total offset value stored in a database. The total offset value can be a sum of the pending offset values associated with a particular user. If the total offset value does not yet exist, then the network computer 410 can set the total offset value to the determined offset value.

At step S418, after determining the offset value, the network computer 410 can transmit the authorization request message to the authorizing entity computer 412. In some embodiments, the network computer 410 can transmit the authorization request message to the authorizing entity computer 412 concurrently with determining the offset value (e.g., steps S416 and S418).

At step S420, after receiving the authorization request message, the authorizing entity computer 412 can determine whether or not to authorize the transaction associated with the authorization request message, as described herein. The authorizing entity computer 412 can then transmit an authorization response message to the network computer 410 (not shown in FIG. 4). The authorization response message can then be forwarded to the other computers as described in steps S324-S332 in FIG. 3.

At step S422, the system can perform steps S402-S420 any suitable number of times for subsequent transactions. For example, the user of the portable device 402 may perform 5 different transactions at different times between various merchants and/or cardholders. Each transaction may initiate the steps performed in steps S402-S420.

At step S424, after any suitable number of transactions have been performed, the network computer 410 can determine if the total offset value associated with the user exceeds an offset threshold. In some embodiments, the network computer 410 can determine if the total offset value exceeds the offset threshold after each time the network computer determines an offset value.

The offset threshold can be a predetermined threshold. In some embodiments, the offset threshold may be set by the user. In other embodiments, the offset threshold may be set by the resource provider. As an example, the offset threshold can be $20, $55, $200, $1000, $5000, etc. If the total offset value does not exceed the offset threshold, then the network computer 410 can determine not to notify the user. The network computer 410 can then perform any of the preceding steps (e.g., steps S402-S422). If the total offset value exceeds the offset threshold, then the network computer 410 can continue to step S426.

At step S426, after determining that the total offset value exceeds the offset threshold, the network computer 410 can transmit a notification including the total offset value to a remote computer 414. The remote computer 414 can be any suitable computer operated by an entity. For example, in some embodiments, the remote computer 414 may be a user device operated by the user of the portable device 402. In other embodiments, the remote computer 414 may be the portable device 402. In other embodiments, the remote computer 414 can be a server computer operated by an entity such as a resource provider, an issuer, an acquirer, an environmental protection group, manufacturer or any other suitable entity.

In some embodiments, the user may receive the notification including the total offset value (e.g., $100). The offset value may be an amount of money that may be donated to an environmental charity to counteract the environmental impact of the user's transactions. After receiving the notification, the user can determine to donate $100 (or other amount) to an environmental charity. In some embodiments, the user may respond to the notification and indicate for the network computer 410 to donate an amount equal to the total offset value on the user's behalf to an environmental charity. For example, the total offset value may be the cost to plant trees required to remove the amount of carbon from the atmosphere that was released in the manufacturing of the user's purchased item. In some embodiments, the network computer 410 can receive a response indicating to apply the offset value. The network computer 410 can then apply the offset value to an account associated with the user device. For example, the network computer 410 can invoice the user for the offset value, record the offset value, and can accrue the offset value in an escrow account.

After receiving payment, the network computer 410 can electronically deposit the offset value in the escrow account and may remove the accrual. Periodically, the network computer 410 can cause the electronic deposits stored within the escrow account to be donated (e.g., transferred) to an environmental charity. For example, the environmental charity could work to reduce carbon (e.g., by planting trees) or to cut emissions of greenhouse gases (e.g., renewable energy projects such as solar power). Periodically, the authorizing entity computer 412 may send the user a report of the offset amounts, associated with the user, given to the environmental charity, which can be used for tax purposes. The environmental charity may be selected or pre-selected by the network computer 410, the authorizing entity computer 412, or selected by the user of the portable device 402.

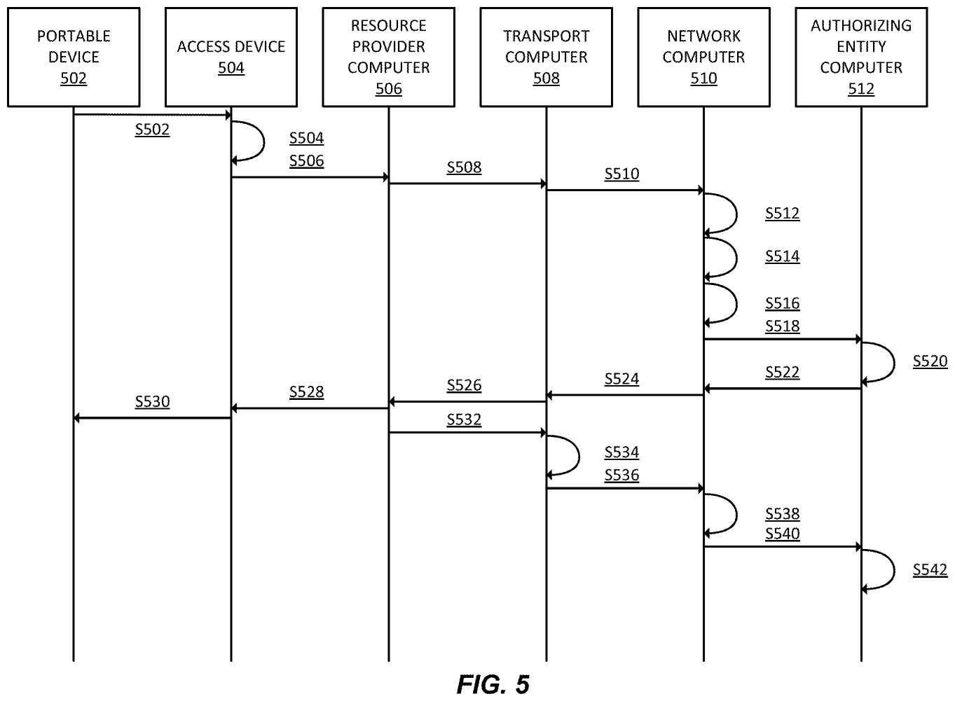

FIG. 5 shows a flow diagram illustrating a clearance and carbon offset method according to some embodiments. The method illustrated in FIG. 5 will be described in the context of a transaction involving carbon offset values as well as a clearance and settlement process. It is understood, however, that the teachings of these embodiments can be applied to other circumstances (e.g., other types of offset values, other interactions, etc.). Although the steps are illustrated in a specific order, it is understood that embodiments may include methods that have the steps in different orders. In addition, in some embodiments, steps may be omitted or added.

Steps S502-S514 are substantially similar to steps S302-S314 described above and will not be repeated here. At step S516, the network computer 510 can determine an offset value based on product data received in steps S502-S514. The network computer 510 can determine the offset value in any suitable manner described herein. For example, the network computer 510 can obtain offset data from an offset data database and then determine the offset value using the offset data and the product data. In some embodiments, the network computer 510 can store the offset value in a database. The offset value can be stored in association with a transaction identifier for the transaction. At step S518, the network computer 510 can transmit an authorization request message to the authorizing entity computer 512, as described herein. The authorization request message can include access data and transaction data.

Steps S520-S530 are substantially similar to steps S322-S332 described above and will not be repeated here. Steps S502-S530 may be repeated any suitable number of times for a plurality of transactions between users and resource providers. In some embodiments, when the network computer 510 receives an authorization response message from the authorizing entity computer 512, at step S522, the authorization response message can include an authorization code. The network computer 510 can store the authorization code in reference to the transaction identifier. In this way, the network computer 510 can later use the authorization code and/or the transaction identifier to determine the product data and the offset value.

At step S532, after any suitable amount of time, such as at the end of a day, the resource provider computer 506 can transmit authorized transaction records that occurred during the day to the transport computer 508. The authorized transaction records may be records of each authorized transaction. For example, the resource provider computer 506 may perform 5 transactions in a day. At the end of the day, the resource provider computer 506 can collect a record for each authorized transaction. The record can include any suitable information such as a transaction identifier, an authorization code, a transaction amount, an issuer identification number (IIN), and/or product data. Steps S532-S542 may be referred to as a clearance process.

At step S534, after receiving the authorized transaction records from the resource provider computer 506, the transport computer 508 may validate the authorized transaction records. For example, the transport computer 508 may validate a received authorized transaction record by determining if the received authorized transaction record includes an authorization code previously received in an authorization response message. The transport computer 508 may validate an authorized transaction record in any suitable manner, such as validating a transaction identifier that the transport computer 508 stored when it received an authorization response message.

After validating the received authorized transaction records, the transport computer 508 may create a batch file including the authorized transaction records that are associated with the authorizing entity computer 512. For example, each authorized transaction record may include an issuer identification number (IIN). The transport computer 508 may collect the authorized transaction records that include the same IIN into the batch file. At step S536, the transport computer 508 may transmit the batch file to the network computer 510. In some embodiments, the batch file can include transaction records received from a plurality of resource provider computers.

At step S538, after receiving the batch file, the network computer 510 may apply an offset value to a transaction amount in the batch file. In some embodiments, the batch file may include a batch transaction amount, which may be the sum of each transaction amount of each transaction in the batch file. The network computer 510 may determine a batch offset value, which may be the sum of each offset value of each transaction in the batch file. The network computer 510 can apply the batch offset value to the batch transaction amount.

For example, the batch file can include 5 transactions with transaction amounts $5, $20, $25, $50, and $100, which may have occurred between different merchants and/or cardholders. The batch transaction amount may be $200. The network computer 510 can determine which offset values are associated with the transaction identifiers included in the batch file. The offset values may be $1, $4, $5, $10, and $18. The network computer 510 can determine the batch offset value to be $38. The network computer 510 can apply the batch offset value to the batch transaction amount, e.g., $200+$38=$238. The network computer 510 can adjust the batch transaction amount to be $238, resulting in an adjusted batch transaction amount. The network computer 510 can include the adjusted batch transaction amount in a batch file.

In some embodiments, the network computer 510 can collect the batch files containing transactions in various currencies from different transport computers (e.g., transport computer 508). For example, the network computer 510 may receive a plurality of batch files from a plurality of transport computers. Batch files received from different transport computers in different currencies can be sorted according to the IIN associated with the transaction. A separate IIN batch file can be compiled for each authorizing entity computer 512. Each IIN batch file can contain transactions performed with one type of portable device 502, while the transaction amounts may be expressed in various currencies. These currencies can be different from the billing currency, which is the currency in which the billing of the user account is performed.

At step S540, after applying an offset value to the transaction amount of the batch file and grouping batch files into an IIN batch file, the network computer 510 may transmit the IIN batch file to the authorizing entity computer 512. At step S542, the authorizing entity computer 512 can receive IIN batch files compiled by the network computer 510. Using a transaction identifier associated with an authorized transaction record, the authorizing entity computer 512 can match each transaction received during clearing against an authorization database, containing all the previously accepted or rejected authorization request messages. All of the matching records can be separately compiled. In some embodiments, for each authorized transaction record received from the network computer 510, a currency exchange operation may be performed from the currency in which the amount at the access device 504 is expressed to the billing currency agreed by the authorizing entity computer 512. The authorized transaction records can be sorted according to the PAN corresponding to each user, and a statement file can be separately compiled for each user. The authorizing entity computer 512 may know all the information it needs to settle payment with the users. The authorizing entity computer 512 can recover the adjusted transaction amount during the clearing period by billing the users. The total in each statement file, corresponding to a user, can be computed. In some embodiments, for portable devices that are debit cards, the resulting total amount is debited directly from the user's account kept with the authorizing entity computer 512. In other embodiments, for portable devices that are credit cards, the total of the statement file can be posted to a temporary account linked to the user's account, updating its balance, which is held until the statement billing time. The remaining portion of the adjusted batch transaction amount can be included in an adjusted batch file.

In some embodiments, after step S540, the network computer 510 may transmit the IIN batch file to the transport computer 508. The transport computer 508 may evaluate the adjusted batch transaction amount included in the IIN batch file.

After the clearing of the transactions carried out in a well-defined time period is performed, settlement can be performed. The three devices involved in the processing of a transaction (namely, the authorizing entity computer 512, the transport computer 508, and the network computer 510) are reimbursed for their services. The network computer 510 can compute compensations between transport computers and authorizing entity computers. The transfer of funds may be performed through a settlement bank, which may be designated by the network computer 510 and which can handle various currencies. Both the transport computers and the authorizing entity computers may have an account with this bank.

In some embodiments, the settlement process can be schematized as follows. The batch files compiled by the network computer 510 containing the transaction data that was submitted for clearing to the authorizing entity computer 512 with transaction amounts in various currencies can be submitted to a currency exchange procedure with currency exchange rates provided by the settlement bank. The amount in each transaction record of the batch file can be converted from the card acceptor's currency, which is the local currency at the access device 504, to a settlement currency agreed by each authorizing entity computer 512. After all the transaction amounts are converted in the authorizing entity computer's 512 settlement currency, a total is computed that reflects the amount to be debited from the authorizing entity computer's 512 account kept with the settlement bank. The authorizing entity computer 512 can be notified about the settlement of its debt. The network computer 510 may repeat this process for each authorizing entity computer 512 that participated in the clearing.

In some embodiments, the network computer 510 may transmit a notification to a remote computer operated by a manufacturer that manufactured the products involved in the transaction. The network computer 510 can indicate for the remote computer to pay for the offset value. The network computer 510 can determine the manufacturing computer associated with the offset value based on the previously received product data, which may include a manufacturer product number. The manufacturer may transfer funds to the network computer 510, the transport computer 508, and/or the authorizing entity computer 512. In other embodiments, the network computer 510 may transmit an invoice for the offset value to the manufacturer computer. The manufacturer computer can then respond to the invoice and transfer funds to the network computer 510.

In yet other embodiments, as described herein, the user can pay for the offset values associated with transactions that the user performed. The authorizing entity computer 512, may front the cost of the offset value during the settlement process and may accordingly bill the users for the offset value. For example, the authorizing entity computer 512 may hold the user's account and may deduct the offset value from the user's account at any suitable time.

In some embodiments, the resource provider may pay for the offset values associated with transactions that the resource provider performed. The transport computer 508 and/or network computer 510 may front the cost of the offset value during the settlement process and may accordingly bill the resource provider for the offset value. For example, the transport computer 508 may hold the resource provider's account and may deduct the offset value from the resource provider's account at any suitable time. In other embodiments, the transport computer 508 may deduct the offset value before transferring the settlement funds. For example, the resource provider computer 506 may have performed a transaction of $50 with an offset value of $5. During settlement, the network computer 510 may transfer $45 to the transport computer 508, which can transfer $45 to the resource provider computer 506. The network computer 510 may then donate the offset value of $5 to an environmental charity on the behalf of the resource computer.

The network computer 510 can process the batch file received from each transport computer 508 and can compute a total of the transaction amounts of all the records in the batch file. The resulting value can be credited in the transport computer's 508 account kept with the settlement bank. The transport computer 508 may be notified about the crediting of its account. The network computer 510 can repeat this process for each transport computer 508 that participated in the clearing. Each transport computer 508 may credit the amount in each card acceptor master file to the corresponding account, which may end the settlement process.

In some embodiments, any combination of the above described steps may be performed. For example, in some embodiments, a network computer may adjust the authorization request message based on an offset value determined during a transaction (e.g., S318 in FIG. 3). The network computer may also notify a user of a portable device about the offset value (e.g., S424-S426 in FIG. 4) used to adjust the authorization request message. The network computer may then also perform a clearance process (e.g., S532-S542 in FIG. 5).

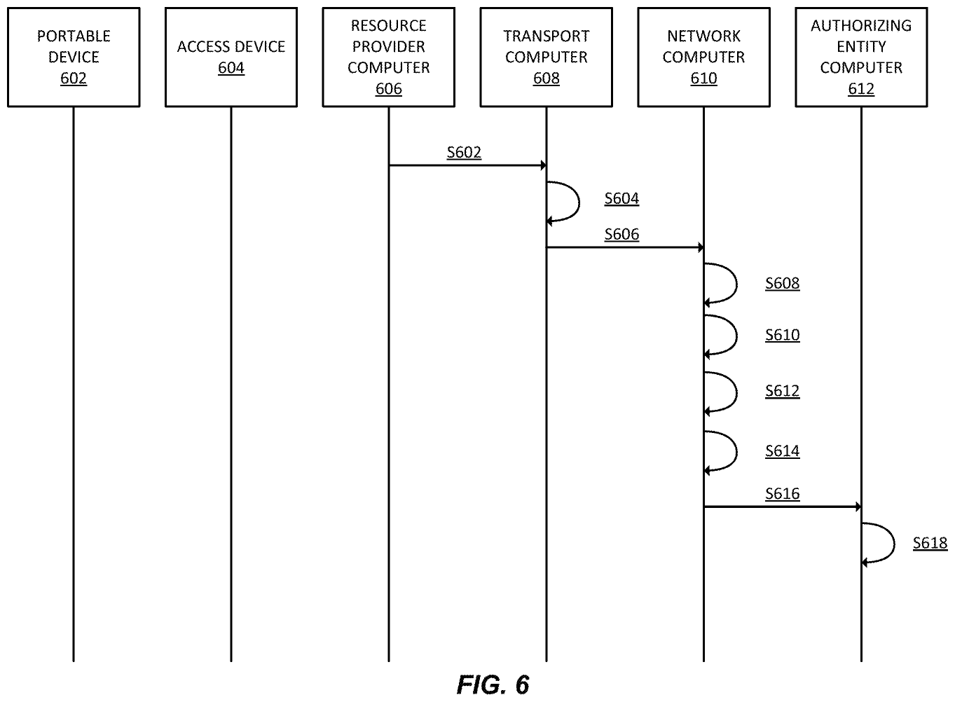

FIG. 6 shows a flow diagram illustrating an alternate clearance and carbon offset method according to some embodiments. The method illustrated in FIG. 6 will be described in the context of a transaction as well as a clearance and settlement process involving carbon offset values. It is understood, however, that the teachings of these embodiments can be applied to other circumstances (e.g., other types of offset values, other interactions, etc.). Although the steps are illustrated in a specific order, it is understood that embodiments may include methods that have the steps in different orders. In addition, in some embodiments, steps may be omitted or added.

Before step S602, a portable device 602, an access device 604, a resource provider computer 606, a transport computer 608, a network computer 610, and an authorizing entity computer 612 may perform an interaction, such as a transaction, authorization process. For example, the portable device 602 may interact with the access device 604. The access device may create access data and transmit an authorization request message comprising access data to the transport computer 608. The transport computer 608 may forward the authorization request message to the network computer 610 which may forward the authorization request message to the authorizing entity computer 612. The authorizing entity computer 612 may determine whether or not to authorize the interaction and may also generate and transmit an authorization response message to the network computer 610. The network computer 610 may forward the authorization response message to the access device 604.

At step S602, after any suitable amount of time, such as at the end of a day, the resource provider computer 606 can transmit authorized transaction records that occurred during the day to the transport computer 608. The authorized transaction records may be records of each authorized transaction. For example, the resource provider computer 606 may perform 5 transactions in a day. At the end of the day, the resource provider computer 606 can collect a record for each authorized transaction. The record can include any suitable information such as a transaction identifier, an authorization code, a transaction amount, an issuer identification number (IIN), and/or product data. Steps S602-S618 may be referred to as a clearance process.

The resource provider 606 may also transmit product data, for example SKU-level data, to the transport computer 608. The product data may correspond to goods and/or services purchased in a transaction. Each authorized transaction of the records of each authorized transaction can be associated with product data using, for example, a transaction identifier.

At step S604, after receiving the authorized transaction records from the resource provider computer 606, the transport computer 608 may validate the authorized transaction records. For example, the transport computer 608 may validate a received authorized transaction record by determining if the received authorized transaction record includes an authorization code previously received in an authorization response message. The transport computer 608 may validate an authorized transaction record in any suitable manner, such as validating a transaction identifier that the transport computer 608 stored when it received an authorization response message.

After validating the received authorized transaction records, the transport computer 608 may create a batch file including the authorized transaction records that are associated with the authorizing entity computer 612. For example, each authorized transaction record may include an issuer identification number (IIN). The transport computer 608 may collect the authorized transaction records that include the same IIN into the batch file. The transport computer 608 may also collect product data associated with each of the transactions collected into a batch file. In some embodiments, the product data may be include directly into the batch file along with transaction identifiers and the transaction data. In other embodiments, the product data may be included in a batch product file.

At step S606, the transport computer 608 may transmit the batch file including transaction records as well as product data to the network computer 610. In some embodiments, the batch file can include transaction records received from a plurality of resource provider computers. In other embodiments, the transport computer 608 may transmit the batch file as well as the batch product file to the network computer 610. In yet other embodiments, the transaction records and the product data may be included in a settlement/clearing message, which can be transmitted to the network computer. For example merchants can provide level III SKU data as part of a record in a Basell TCR3 message.

At step S608, after the batch file, the network computer 610 can determine if a portable device (e.g., portable device 602) associated with each transaction in the batch file is enrolled in a carbon offset program. For example, the network computer 610 can query a carbon offset enrollment database for a user profile associated with the PAN, or other user identifier, from authorized transactions in the batch file. The network computer 610 can determine whether or not the user previously created a user profile during enrollment into the carbon offset program. If the network computer 610 determines that the portable device 602 is not enrolled in the carbon offset program, then the network computer 610 can proceed with clearance and can determine if the next (i.e., a different) authorized transaction in the batch file corresponds with an enrolled portable device. The network computer 610 may be configured to determine if a portable device is enrolled in a carbon offset program for each authorized transaction in the batch file.

At step S314, after determining whether or not each authorized transaction corresponds to an enrolled portable device, the network computer 610 can determine if the resource provider computer (e.g., the resource provider computer 606) associated with an authorized transaction in the batch file is enrolled in the carbon offset program. For example, the network computer 610 can query the carbon offset enrollment database for a merchant profile associated with the access device 604 and/or the resource provider computer 606. In some embodiments, the user profiles and the merchant profiles may be stored in the same carbon offset enrollment database. In other embodiments, the user profiles may be stored in a user profile database, whereas the merchant profiles may be stored in the merchant profile database. If the network computer 610 determines that the resource provider computer 606 is not enrolled in the carbon offset program, then the network computer 610 can proceed determine if a next authorized transaction in the batch file corresponds to an enrolled merchant profile.

In some embodiments, the network computer 610 may perform step S608 and not perform S610. In other embodiments, the network computer 610 may perform step S610 and not S608. The network computer 610 may determine the entities that are enrolled in the carbon offset program. For example, the carbon offset program may allow users to pay for the cost of a carbon offset for each of the user's purchases. In this case, the network computer 610 may determine if the user is enrolled in the carbon offset program. As another example, the carbon offset program may allow merchants to pay for the cost of a carbon offset for each item sold by the merchant. In this case, the network computer 610 may determine if the merchant is enrolled in the carbon offset program.

At step S612, after verifying that the portable device 602 and/or the resource provider computer 606 corresponding to an authorized transaction in the batch file are enrolled in the carbon offset program, the network computer 610 can determine an offset value for the authorized transaction based on the product data with the same transaction identifier. For example, the product data may indicate that the user is purchasing 10 gallons of unleaded gasoline from a gas station. The network computer 610 can query an offset data database for carbon offset data regarding the product data (e.g., unleaded gasoline). In some embodiments, the network computer 610 may obtain a table of various amounts of different types of gasoline and their carbon costs. The network computer 610 can determine the offset value based on the carbon cost of 10 gallons of unleaded gasoline. In some embodiments, the network computer 610 may determine an estimate for the amount of carbon generated in the creation of the 10 gallons of unleaded gasoline and its provision to the user, then determine the offset value based on the amount of carbon.

In other embodiments, the network computer 610 can obtain a carbon equation that relates the product data to the amount of carbon generated. The carbon equation can compute an estimate of the amount of carbon created based on inputs (e.g., product data). For example, the inputs to the carbon equation may be amount of fuel (e.g., 10 gallons) and type of fuel (e.g., unleaded gasoline), which may be included in the product data. The carbon equation may be predetermined and stored in the carbon offset data database.

The network computer 610 can determine an offset value for each of the authorized transactions in the batch file that correspond to entities enrolled in the offset program. The network computer 610 can determine any suitable number of offset values for the batch file based on received product data.

At step S614, after determining the offset value(s), the network computer 610 may apply the offset value(s) to a transaction amount in the batch file. In some embodiments, the batch file may include a batch transaction amount, which may be the sum of each transaction amount of each transaction in the batch file. The network computer 610 may determine a batch offset value, which may be the sum of each offset value of each transaction in the batch file. The network computer 610 can apply the batch offset value to the batch transaction amount. The network computer 610 group batch files into an IIN batch file as described herein.

At step S616, the network computer 610 may transmit the IIN batch file to the authorizing entity computer 612. At step S618, the authorizing entity computer 612 can receive IIN batch files compiled by the network computer 610. Using a transaction identifier associated with an authorized transaction record, the authorizing entity computer 612 can match each transaction received during clearing against an authorization database, containing all the previously accepted or rejected authorization request messages. All of the matching records can be separately compiled. The authorized transaction records can be sorted according to the PAN corresponding to each user, and a statement file can be separately compiled for each user. The authorizing entity computer 612 may know all the information it needs to settle payment with the users. The authorizing entity computer 612 can recover the adjusted transaction amount during the clearing period by billing the users. The total in each statement file, corresponding to a user, can be computed.

In yet other embodiments, authorization amounts (i.e., transaction amount when authorized by the authorizing entity computer) may be different than the final settled amount requested by the user, particularly for some purchases like fuel, where a merchant can be capable of pre-authorizing a portable device, such as a card, for up to certain amount then settles for the actual amount of fuel pumped. By using the settlement data instead of authorization data, embodiments may trigger the correct carbon offset, as described herein. For example, in some embodiments, an offset value may be determined, by the network computer, after receiving an authorization request message comprising product data. In other embodiments, an offset value may be determined, by the network computer, after receiving product data from a resource provider during clearance.

The teachings of this disclosure have a number of advantages. For example, a network computer can determine an offset value which can be applied to a transaction amount directly in an authorization request message before an authorizing entity computer authorizes the transaction. Some embodiments allow for the network computer to determine an offset value based on product data of a transaction, thus increasing the accuracy calculations of offset values over prior systems. Likewise, the offset value is determined automatically and without user intervention. Additionally, the offset value is able to be calculated in real-time, thus improving the efficiency of carbon offset purchases.

Another advantage is that users may be able to seamlessly purchase carbon offsets. Some embodiments allow the user to enroll in a carbon offset program that determines and applies offset values directly to a transaction amount based on product data from the transaction. Some embodiments improve the efficiency of determining carbon offsets for a transaction. This saves the user from performing many steps to become carbon neutral. By reducing the work needed for a user to become carbon neutral (e.g., removing barriers to entry), more users can decide to become carbon neutral, thus positively impacting the environment.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium, according to an embodiment may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations will become apparent to those skilled in the art upon review of the disclosure. The scope of the embodiments should, therefore, be determined not with reference to the above description, but instead should be determined with reference to the pending claims along with their full scope or equivalents.

One or more features from any embodiment may be combined with one or more features of any other embodiment without departing from teachings of this disclosure.

As used herein, the use of “a,” “an,” or “the” is intended to mean “at least one,” unless specifically indicated to the contrary.

What is claimed is:

1. A method comprising:
receiving, by a network computer, an authorization request message comprising access data;
receiving, by the network computer, product data for a transaction;
determining, by the network computer, an offset value based on the product data; and
performing additional processing, by the network computer, based upon the offset value.

2. The method of claim 1, wherein performing additional processing further comprises:
adjusting, by the network computer, a transaction value in the authorization request message using the offset value;
generating, by the network computer, a modified authorization request message; and
transmitting, by the network computer, the modified authorization request message to an authorizing entity computer.

3. The method of claim 1, wherein performing additional processing further comprises:
storing, by the network computer, the offset value; and
applying, by the network computer, the offset value in a clearance process.

4. The method of claim 1, wherein performing additional processing further comprises:
transmitting, by the network computer to a user device, a notification regarding the offset value;
receiving, by the network computer from the user device, a response with an indication to apply the offset value; and
applying, by the network computer, the offset value to an account associated with the user device.

5. The method of claim 1, wherein the authorization request message comprises the access data and the product data.

6. The method of claim 1, wherein network computer receives the authorization request message via a first communications channel, and wherein the network computer receives the product data via a second communications channel.

7. The method of claim 1, wherein the transaction is performed between a portable device and an access device, and wherein the network computer receives the authorization request message from the access device.

8. The method of claim 7 further comprising:
determining, by the network computer, whether or not the portable device is enrolled in a carbon offset program.

9. The method of claim 7 further comprising:
determining, by the network computer, whether or not a resource provider associated with the access device is enrolled in a carbon offset program.

10. The method of claim 1, wherein determining the offset value based on the product data further comprises:
querying, by the network computer, an offset data database for offset data associated with the product data;
receiving, by the network computer from the offset data database, offset data; and
determining, by the network computer, the offset value based on the offset data.

11. A server computer comprising:
a processor;
a memory device; and
a non-transitory computer-readable medium coupled to the processor, the non-transitory computer-readable medium comprising code executable by the processor for implementing a method comprising:
receiving an authorization request message comprising access data receiving product data for a transaction;
determining an offset value based on the product data; and
performing additional processing based upon the offset value.

12. The server computer of claim 11, wherein performing additional processing further comprises:
adjusting a transaction value in the authorization request message using the offset value;
generating a modified authorization request message; and
transmitting the modified authorization request message to an authorizing entity computer.

13. The server computer of claim 11, wherein performing additional processing further comprises:
storing the offset value; and
applying the offset value in a clearance process.

14. The server computer of claim 11, wherein performing additional processing further comprises:
transmitting, to a user device, a notification regarding the offset value;
receiving, from the user device, a response indicating to apply the offset value; and
applying the offset value to an account associated with the user device.

15. The server computer of claim 11, wherein the authorization request message comprises the access data and the product data.

16. The server computer of claim 11, wherein network computer receives the authorization request message via a first communications channel, and wherein the network computer receives the product data via a second communications channel.

17. The server computer of claim 11, wherein the transaction is performed between a portable device and an access device, and wherein the server computer receives the authorization request message from the access device.

18. The server computer of claim 17, wherein the method further comprises:
determining whether or not the portable device is enrolled in a carbon offset program.

19. The server computer of claim 17, wherein the method further comprises:
determining whether or not a resource provider associated with the access device is enrolled in a carbon offset program.

20. The server computer of claim 11, wherein determining the offset value based on the product data further comprises:
querying an offset data database for offset data associated with the product data;
receiving, from the offset data database, offset data; and
determining the offset value based on the offset data.
